(19) United States
(12) Patent Application Publication
(10) Pub. No.: US 2020/0294141 A1
(43) Pub. Date: Sep. 17, 2020

(54) CREDIT GUARANTEE-BASED SERVICE PROCESSING

(71) Applicant: Alibaba Group Holding Limited, George Town (KY)

(72) Inventors: Fengwei Wang, Hangzhou (CN); Huimei He, Hangzhou (CN); Xing Zhao, Hangzhou (CN); Jie Li, Hangzhou (CN); Lin Zhu, Hangzhou (CN)

(73) Assignee: Alibaba Group Holding Limited, George Town (KY)

(21) Appl. No.: 16/888,549

(22) Filed: May 29, 2020

Related U.S. Application Data
(63) Continuation of application No. PCT/CN2019/079191, filed on Mar. 22, 2019.

(30) Foreign Application Priority Data
Jun. 22, 2018 (CN) 201810650694.1

(51) Int. Cl. G06Q 40/02; G06Q 30/06; G06Q 10/10; H04L 29/06

(52) U.S. Cl. CPC G06Q 40/025; G06Q 30/0645; H04L 63/0853; H04L 63/102; G06Q 10/109

(57) ABSTRACT

A computer-implemented method includes determining, by one or more processing devices, that a credit rating of a first user does not satisfy a permission condition of the service; generating, by the one or more processing devices, an assistance request shareable with at least a second user, the assistance request including a request for the second user to authorize use of a credit rating of the second user to endorse the first user; displaying assistance progress information representing a relative status with respect to a goal; receiving, by the one or more processing devices, information indicating the second user's authorization; and determining, by the one or more processing devices, an update to the relative status, the updated relative status being determined based on respective credit ratings of the first user and the second user.

### CROSS-REFERENCE TO RELATED APPLICATIONS

This application is a continuation of PCT Application No. PCT/CN2019/079191, filed on Mar. 22, 2019, which claims priority to Chinese Patent Application No. 201810650694.1, filed on Jun. 22, 2018, and each application is hereby incorporated by reference in its entirety.

### TECHNICAL FIELD

The present specification relates to the field of computer software technologies, and in particular, to credit guarantee-based service processing methods, apparatuses, and devices.

### BACKGROUND

The popularization of smartphones brings convenience to people's lives. By using various applications on the smartphones, various services including product renting services can be correspondingly performed.

At present, needs for product renting are increasing. On the one hand, products that are less frequently used and used only for a short time, such as wedding clothes, travel equipment, and maternal and infant products, do not need to be purchased and can be rented for a period of time. On the other hand, many high-tech products, such as drones and new mobile phones, can be rented at relatively low costs without having to be purchased.

The biggest obstacle to the user using the renting service is the deposit. For example, assume that the price of a drone is RMB 10,000, and if the deposit is also RMB 10,000, the costs are too high for many users. However, the deposit is different from the rental fee. If the user returns the product on time, the deposit will be returned to the user. Therefore, if a user is sure to return the product on time, the deposit can be exempted in advance to reduce renting costs of the user.

Determining whether a user can return the product on time is essentially evaluating the user's credit rating (such as a credit score and a credit rank). Based on evaluation results, a deposit exemption scheme can be formulated. For example, deposits of different amounts are exempted based on different credit ratings.

However, due to lack of credit evaluation records and other reasons, the credit ratings of many users fail to meet deposit exemption criteria. As such, the users cannot use the deposit-free renting services temporarily and need to accumulate their credit ratings continuously.

### SUMMARY

Implementations of the present specification provide credit guarantee-based service processing methods, apparatuses, and devices, so as to help more users conveniently use a deposit-free renting service.

To alleviate the previous technical problem, the implementations of the present specification are implemented as described below.

An implementation of the present specification provides a credit guarantee-based service processing method, including: determining, based on a credit rating of a first user, that the first user has not reached a permission condition of a specified service, where the permission condition includes that credit rating is not less than a specified threshold; generating an assistance request, used to request one or more second users to use credit ratings of the one or more second users to endorse the first user; displaying assistance progress information of the first user to represent a credit rating growth status of the first user based on assistance of other users; if the second user agrees to the assistance request, obtaining a credit rating of the first user after being assisted that is calculated based on respective credit ratings of the first user and the second user; and permitting the first user to use the specified service if the credit rating obtained after the assistance enables the first user to meet the permission condition.

An implementation of the present specification provides another credit guarantee-based service processing method, including: receiving an assistance request sent by a first user to a second user, where the assistance request is used to request the second user to use a credit rating of the second user to endorse the first user; displaying assistance progress information of the first user to represent a credit rating growth status of the first user based on assistance of other users; in response to an operation indicating that the second user agrees to the assistance request, obtaining a credit rating of the first user after being assisted that is calculated based on respective credit ratings of the first user and the second user, so as to update the assistance progress information.

An implementation of the present specification provides a credit guarantee-based service processing apparatus, including: a determining module, configured to determine, based on a credit rating of a first user, that the first user has not reached a permission condition of a specified service, where the permission condition includes that a credit rating is not less than a specified threshold; a generation module, configured to generate an assistance request, used to request one or more second users to use credit ratings of the one or more second users to endorse the first user; a display module, configured to display assistance progress information of the first user to represent a credit rating growth status of the first user based on assistance of other users; an acquisition module, configured to: if the second user agrees to the assistance request, obtain a credit rating of the first user after being assisted that is calculated based on respective credit ratings of the first user and the second user; and a permission module, configured to permit the first user to use the specified service if the credit rating obtained after the assistance enables the first user to meet the permission condition.

An implementation of the present specification provides another credit guarantee-based service processing apparatus, including: a receiving module, configured to receive an assistance request sent by a first user to a second user, where the assistance request is used to request the second user to use a credit rating of the second user to endorse the first user; a display module, configured to display assistance progress information of the first user to represent a credit rating growth status of the first user based on assistance of other users; an acquisition module, configured to: in response to an operation indicating that the second user agrees to the assistance request, obtain a credit rating of the first user after being assisted that is calculated based on respective credit ratings of the first user and the second user, so as to update the assistance progress information.

An implementation of the present specification provides a credit guarantee-based service processing device, including: at least one processor; and a memory communicatively connected to the at least one processor; where the memory stores instructions that can be executed by the at least one processor, and the instructions are executed by the at least one processor, to enable the at least one processor to: determine, based on a credit rating of a first user, that the first user has not reached a permission condition of a specified service, where the permission condition includes that a credit rating is not less than a specified threshold; generate an assistance request, used to request one or more second users to use credit ratings of the one or more second users to endorse the first user; display assistance progress information of the first user to represent a credit rating growth status of the first user based on assistance of other users; if the second user agrees to the assistance request, obtain a credit rating of the first user after being assisted that is calculated based on respective credit ratings of the first user and the second user; and permit the first user to use the specified service if the credit rating obtained after the assistance enables the first user to meet the permission condition.

An implementation of the present specification provides another credit guarantee-based service processing device, including: at least one processor; and a memory communicatively connected to the at least one processor; where the memory stores instructions that can be executed by the at least one processor, and the instructions are executed by the at least one processor, to enable the at least one processor to: receive an assistance request sent by a first user to a second user, where the assistance request is used to request the second user to use a credit rating of the second user to endorse the first user; display assistance progress information of the first user to represent a credit rating growth status of the first user based on assistance of other users; in response to an operation indicating that the second user agrees to the assistance request, obtain a credit rating of the first user after being assisted that is calculated based on respective credit ratings of the first user and the second user, so as to update the assistance progress information.

The previous at least one technical solution used in the implementations of the present specification can achieve the following beneficial effects: A credit rating of an assisted user is increased temporarily through credit assistance between users, and assistance progress information is displayed intuitively, so the assisted user can use credit-based services such as a deposit-free renting service in a timely and convenient way, thereby providing convenience to more users.

### BRIEF DESCRIPTION OF DRAWINGS

To describe technical solutions in implementations of the present specification or in the existing technology more clearly, the following briefly describes the accompanying drawings needed for describing the implementations or the existing technology. Clearly, the accompanying drawings in the following descriptions merely show some implementations of the present specification, and a person of ordinary skill in the art can still derive other drawings from these accompanying drawings without creative efforts.

FIG. 1 is a schematic flowchart illustrating a credit guarantee-based service processing method, according to an implementation of the present specification;

FIG. 2 is a schematic diagram illustrating a case in which credit assistance succeeds or credit assistance fails, according to an implementation of the present specification;

FIG. 3 is a schematic flowchart illustrating another credit guarantee-based service processing method, according to an implementation of the present specification;

FIG. 4a and FIG. 4b are schematic diagrams illustrating some page effects involved in a specific implementation solution of the previous service processing method in an actual application scenario, according to an implementation of the present specification;

FIG. 5 is a schematic structural diagram illustrating a credit guarantee-based service processing apparatus corresponding to FIG. 1, according to an implementation of the present specification;

FIG. 6 is a schematic structural diagram illustrating a credit guarantee-based service processing apparatus corresponding to FIG. 3, according to an implementation of the present specification.

### DESCRIPTION OF IMPLEMENTATIONS

Implementations of the present specification provide credit guarantee-based service processing methods, apparatuses, and devices.

To make a person skilled in the art better understand the technical solutions in the present specification, the following clearly and comprehensively describes the technical solutions in the implementations of the present specification with reference to the accompanying drawings in the implementations of the present specification. Clearly, the described implementations are merely some rather than all of the implementations of the present application. All other implementations obtained by a person of ordinary skill in the art based on the implementations of the present specification without creative efforts shall fall within the protection scope of the present application.

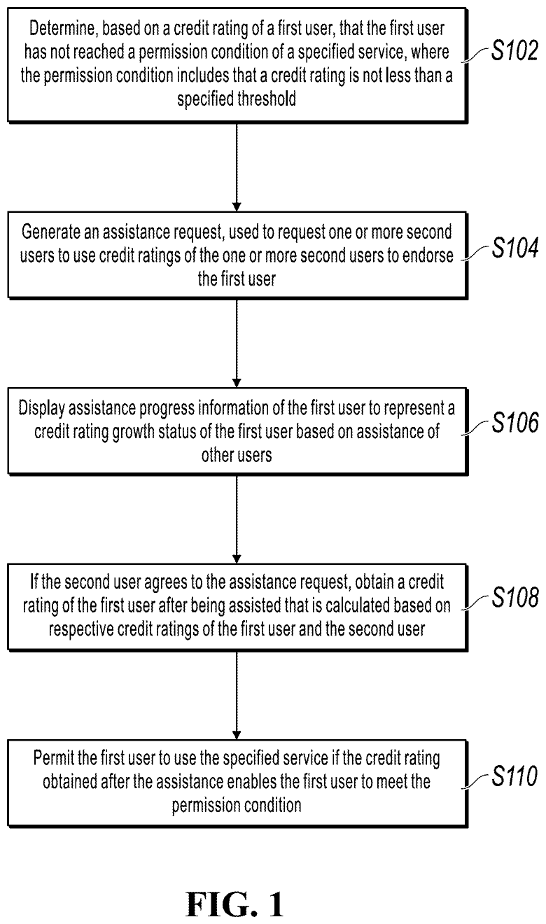

FIG. 1 is a schematic flowchart illustrating a credit guarantee-based service processing method, according to an implementation of the present specification. From a program perspective, an execution embodiment of the procedure can be a client application installed on a terminal device used by a first user, for example, a product renting application, a payment application, or an instant messaging application. The terminal device is, for example, a mobile phone, a tablet computer, a smart watch, or an on-vehicle computer. In addition, a third-party application can also assist in the procedure execution.

The procedure in FIG. 1 can include the following steps.

S102. Determine, based on a credit rating of a first user, that the first user has not reached a permission condition of a specified service, where the permission condition includes that a credit rating is not less than a specified threshold.

In the implementations of the present specification, the credit rating reflects a credit of a user, and it can be considered that a higher credit rating indicates a higher measure of creditworthiness of the user. The credit rating is represented in a numerical form, for example, a credit score and a credit rank, and the numerical form can also be represented in another data form. For example, green indicates a high credit rating, yellow indicates a medium credit rating, and red indicates a low credit rating. The credit rating can be evaluated in various ways, and is not specifically limited here. For example, the credit rating is evaluated based on real information and behavior data of a user on a certain application platform, and is evaluated based on a credit report of the People's Bank of China.

In the implementations of the present specification, the specified service can be a service that is permitted based on the credit rating of the user. For example, the specified service can be a credit-based deposit-free renting service, a credit-based deposit-free reservation service, and a credit-based interest-free installment payment service. It is worthwhile to note that, if necessary, these services can be further classified. For example, the deposit-free renting service may be classified into a full deposit-free renting service and a half deposit-free renting service. The two services can have different respective permission conditions. The permission condition of the full deposit-free renting service is higher than that of the half deposit-free renting service.

In practice, the permission conditions are not limited to conditions related to a credit rating, but can further include some other conditions, for example, a user needs to be of a specified gender. Because this is not mainly concerned in the present specification, the other conditions are not described.

S104. Generate an assistance request, used to request one or more second users to use credit ratings of the one or more second users to endorse the first user.

In the implementations of the present specification, the “first” and “second” are merely used to distinguish between users to prevent conceptual confusion, and are not of practical significance. Multiple second users are different users.

In the implementations of the present specification, the first user can request, by using an assistance request, the second user to provide credit assistance, so as to temporarily increase the credit rating of the first user.

The second user to provide assistance can be intelligently and automatically selected by the client application, or can be selected by the first user. In the former case, for example, the client application can automatically send the generated assistance request to several friends that are in close contact with the first user on a current platform. In the latter case, the client application can directly send the assistance request to each second user selected by the first user, or the client application does not have to directly send the assistance request, but instead provides the assistance request to the first user. The first user sends the assistance request to the second user in a form of content sharing by using a third-party platform. A sending action of the assistance request can be performed by a corresponding third-party client application.

The assistance request itself can be in various forms, for example, an instant message inside a client application, a task, or a token to be shared by a third-party client application.

In the implementations of the present specification, if the second user agrees to the assistance request, the first user can be helped to temporarily increase the credit rating based on at least a part of the credit rating of the second user, that is, the second user guarantees the first user. Credit increment effects can be comprehensively measured based on the credit rating of each second user. There can be various specific measurement methods and examples are described later.

S106. Display assistance progress information of the first user to represent a credit rating growth status of the first user based on assistance of other users.

In the implementations of the present specification, the other users refer to each second user who agrees to the assistance request of the first user.

In the implementations of the present specification, an execution time of step S106 is not limited in the present specification, and can be that the assistance progress information is displayed before the first user sends the assistance request, or can be that the assistance progress information is displayed after the user sends the assistance request.

The assistance progress information can generally be in the form of a progress bar, or certainly can be in a numerical form or other forms. In addition to the credit rating growth status, the assistance progress information can represent other related information such as the difference between the current status of first user to and the permission condition.

Data included in the assistance progress information can be the credit rating itself, or can be other mapping data that can implicitly reflect the credit rating, for example, a percentage and an exemptible deposit amount (for example, when the credit rating is 100, the exemptible deposit amount is 500 yuan; when the credit rating is 200, the exemptible deposit amount is 1000 yuan; when the credit rating is 300, the exemptible deposit amount is 5000 yuan).

S108. If the second user agrees to the assistance request, obtain a credit rating of the first user after being assisted that is calculated based on respective credit ratings of the first user and the second user.

In the implementations of the present specification, the credit rating obtained after assistance can be locally calculated, or can be calculated on a server. The displayed assistance progress information can be updated in real time based on the calculated credit rating obtained after assistance. If multiple second users agree to the assistance request, the assistance progress information can be calculated and updated in real time for multiple times, so the first user knows the assistance progress information in time.

S110. Permit the first user to use the specified service if the credit rating obtained after the assistance enables the first user to meet the permission condition.

In the implementations of the present specification, to encourage mutual credit assistance between users, if the credit rating of the first user obtained after assistance enables the first user to meet the permission condition, a specific reward can be given to the first user and/or the second user that assists the first user, for example, increasing their credit ratings and giving other benefits. In addition, even if assistance fails, the second user who provides assistance can be rewarded.

If the first user fails to fulfil the contract (for example, fails to return the deposit-free rented item on time) after assistance succeeds, the first user and the second user who provides assistance can be punished.

By using the method in FIG. 1, a credit rating of an assisted user is temporarily increased by using credit assistance between users, and assistance progress information is displayed intuitively, so the assisted user can conveniently use a credit-based service such as a deposit-free renting service in time. Therefore, convenience can be provided for more users.

Based on the method in FIG. 1, an implementation of the present specification further provides some specific implementations of the method, which are described below.

In the implementations of the present specification, if the assistance request can be shared on various platforms (for example, a current platform, or a third-party social platform such as a micro blog or a forum), the second user can receive the request in time and respond to the request. Therefore, for step S104, generating an assistance request can specifically include: generating an assistance request in a token form, used to share the assistance request with one or more second users by using a current platform or a third-party platform, so the second user obtains a corresponding operation portal through token verification based on the assistance request. Through the operation portal, the second user can perform an operation indicating that the second user agrees to the assistance request. In addition to the token form, the assistance request can also be in another form such as a webpage link or an SMS message notification.

Further, to improve user experience, text content included in the assistance request can be further specified as needed. For example, for the deposit-free renting service, the text content can be made to: represent a “credit wish” of the first user, so as to prevent the second user from misunderstanding that the first user chooses the deposit-free renting service because the first user lacks money; and also represent the value of credit and that the first user acknowledges the credit of the friend.

In the implementations of the present specification, even if the first user sends the assistance request, the second user may not provide assistance, or even if the second user provides assistance, the first user may be unable to meet the permission condition. Therefore, a determining criterion for an assistance failure can be set, so as to prevent a case that the needs of the first user cannot be met, while resources are unnecessarily occupied, which causes a deadlock. There can be various determining criteria. For example, if a timeout occurs, it is determined that assistance fails, and if there is an excessive quantity of second users that provide assistance, it is determined that assistance fails.

The excessive quantity of second users is used as an example. For the procedure in FIG. 1, for example, the following can be further performed: determining whether the quantity of the second users that agree to the assistance request reaches a specified threshold; and if the specified threshold is reached, but the credit rating obtained after the assistance still fails to enable the first user to meet the permission condition, determining that the assistance fails, and restoring the credit rating of the first user to the credit before the assistance.

In the implementations of the present specification, as mentioned above, there can be various specific methods for measuring the credit increment effects of the second user's assistance on the first user. In the implementations of the present specification, in particular, a measurement method based on an actual relationship between users is provided, so as to help the first user more properly, and help the second user share risks more properly.

Specifically, the second user is preferably a friend of the first user on a current platform and/or a third-party platform. As such, the current platform can at least initially believe that because of the friendship, it is relatively reasonable that the second user helps the first user, and when the second user participates, a probability that the first user subsequently implements contract fulfillment is relatively high. Therefore, temporarily increasing the credit rating of the first user is relatively reliable.

Further, because the friendship only exists on a corresponding platform, the actual relationship between the first user and the second user may not necessarily be reflected. For example, although the first user and the second user are friends in a certain application, in the real world, the first user and the second user may be actually not friends or may be even strangers. Therefore, the friendship is not necessarily reliable. A specific solution can be used to verify the friendship, so as to determine the actual relationship, and then measure the credit increment effects based on the actual relationship, which is more reasonable and reliable. The specific solution is, for example, analyzing interaction between users on a platform, analyzing common points of personal information between users, analyzing real registration information of users, and referring to inter-user relationship data provided by an association platform.

According to the analysis in the previous two paragraphs, for example, for step S108, calculating, based on credit ratings of the first user and the second user, a credit rating of the first user after being assisted can specifically include: verifying the friendship based on information about the first user and information about the second user, so as to determine an actual relationship between the first user and the second user; setting a corresponding relationship weight based on the actual relationship; and calculating, based on the relationship weight, the specified threshold, and the credit ratings of the first user and the second user, the credit rating of the first user after being assisted.

The actual relationship can be graded based on the degree of intimacy and the degree of influence on the user's interests. The degree of intimacy is used an example. Generally, a higher degree of intimacy provides a higher credit guarantee. For example, the actual relationship can be roughly classified into the following three types: a relative or friendship, a schoolmate or colleague relationship, and other relatively unimportant relationships.

Further, the implementations of the present specification further provide an example mathematical equation, which is used to calculate the credit rating of first user after being assisted, and is specifically as follows:

Sᵤ+=(Sᵥ−Sₜ)*W_{u,v}*ζ;

Sᵤ represents a current credit rating of the first user (which is increased for one or more times after the first user is assisted by the second user, so as to become the credit rating obtained after the first user is assisted), Sᵥ represents the credit rating of the second user, Sₜ represents the specified threshold of the credit rating in the permission condition, W_{u,v} represents a relationship weight between the first user and the second user, and ζ represents a damping coefficient, which can be used to, for example, scale an influence weight of a friend, can be a global parameter adjusted as needed, and can be set to 0.1. For example, relationship weights corresponding to the relative or friendship, the schoolmate or colleague relationship, and other relatively unimportant relationships can be respectively set to 2, 1, and 0.1.

Certainly, the credit rating obtained after assistance is calculated in various methods, and is not limited to the previous mathematical equation. For example, the credit rating of the second user and the credit rating of the first user can be simply added as the credit rating obtained after the assistance.

In the implementations of the present specification, for step S106, in addition to the assistance progress information of the first user, some other related information can be displayed. In particular, information that helps strengthen friendship between users or helps enable the first user to implement contract fulfillment subsequently can be displayed, so as to improve user experience.

For example, automatically generated message information (in this case, the user does not need to manually leave a message) and/or message information proactively submitted by each of the second users who have agreed to the assistance request can be displayed, where the displayed message information is used to express at least one of the following intentions: explicitly indicating assistance behavior of each of the second users against the first user, and reminding the first user to implement contract fulfillment for the assistance behavior. In addition, the first user can correspondingly leave a message for interaction, or message information can be automatically generated on behalf of the first user. The message information can encourage the first user to implement contract fulfillment to some extent, and can make the two users feel the credit assistance more intuitively.

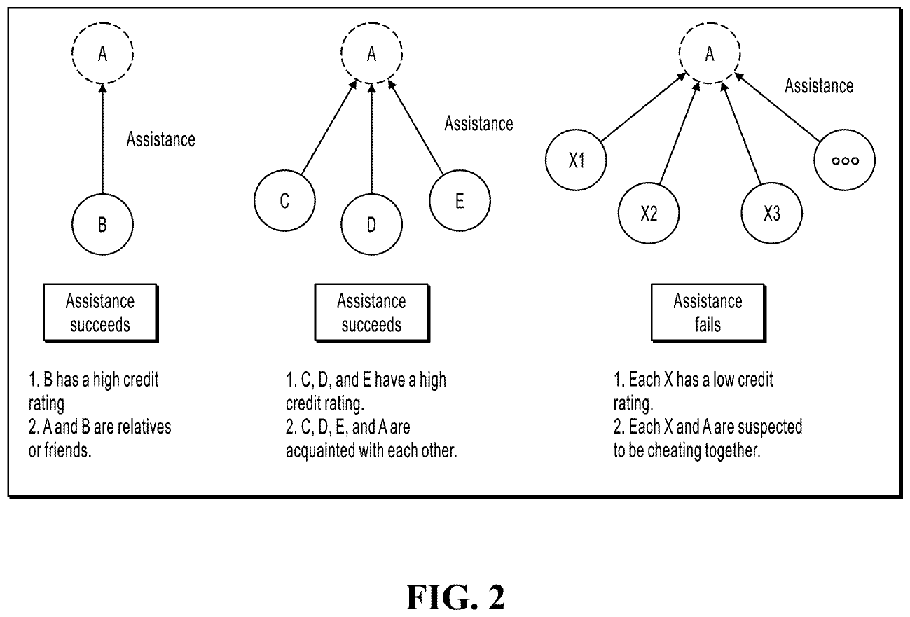

Further, implementations of the present specification further provides a schematic diagram illustrating a case in which credit assistance succeeds or credit assistance fails, so as to facilitate understanding, as shown in FIG. 2.

Three example cases are shown in FIG. 2. On the left side, user B assists user A, and has a high credit rating. If A and B are relatives or friends, the relationship weight is also high. As such, the assistance succeeds. In the middle, users C, D, and E assist user A. C, D, and E have a high credit rating. C, D, E, and A are acquainted with each other. Although the relationship weight is relatively low, the assistance succeeds because a large quantity of users provide assistance. On the right side, multiple different users X assist user A. Because a credit rating of each X is relatively low, and each X and A are suspected to be cheating together, the assistance fails.

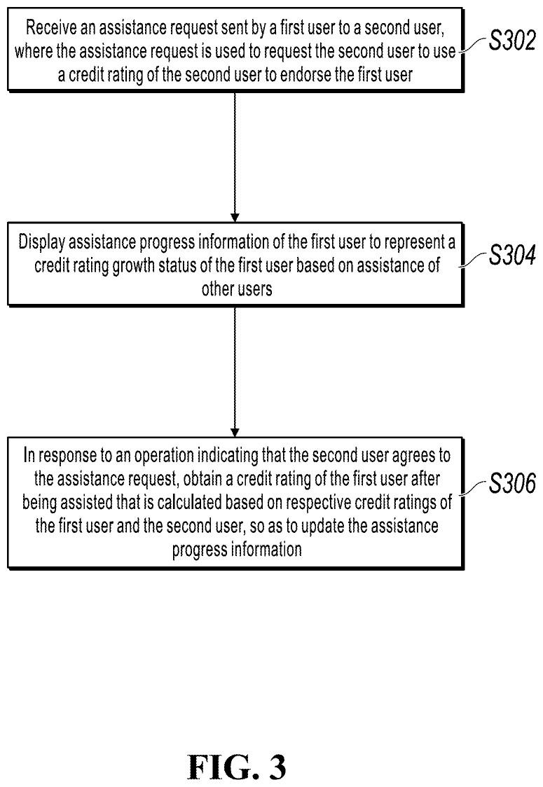

The procedure in FIG. 1 is mainly described from the perspective of the client application of the first user. Based on the same idea, implementations of the present specification further provides a schematic flowchart illustrating another credit guarantee-based service processing method corresponding to FIG. 1, which is described from a perspective of a client application of a second user, as shown in FIG. 3.

The procedure in FIG. 3 can include the following steps.

S302. Receive an assistance request sent by a first user to a second user, where the assistance request is used to request the second user to use a credit rating of the second user to endorse the first user.

In the implementations of the present specification, if the assistance request is a shared token, the second user can copy the token and then open the client application to enter a service page for operating to agree to the assistance request.

S304. Display assistance progress information of the first user to represent a credit rating growth status of the first user based on assistance of other users.

In the implementations of the present specification, the assistance progress information can be displayed not only to the first user, but also can be displayed to the second user, so the second user understands more detailed information, thereby improving a sense of participation and a sense of interaction.

S306. In response to an operation indicating that the second user agrees to the assistance request, obtain a credit rating of the first user after being assisted that is calculated based on respective credit ratings of the first user and the second user, so as to update the assistance progress information.

In the implementations of the present specification, the second user can be further permitted to perform more interaction when providing assistance. For example, the second user leaves a message to the first user to enhance the credit contract fulfillment hint between the user and the friend, for example, leaves a message “Remember to give it back on time” and “Thank you for trusting me”. For another example, the second user obtains some proprietary rights for the first user, for example, unlock dedicated emoji that can be sent to the first user and view more information about the first user.

Similar to the previous description of FIG. 1, for step S304, displaying assistance progress information of the first user can further include: displaying automatically generated message information and/or message information proactively submitted by each of the second users who have agreed to the assistance request, where the displayed message information is used to express at least one of the following intentions: explicitly indicating assistance behavior of each of the second users against the first user, and reminding the first user to implement contract fulfillment for the assistance behavior.

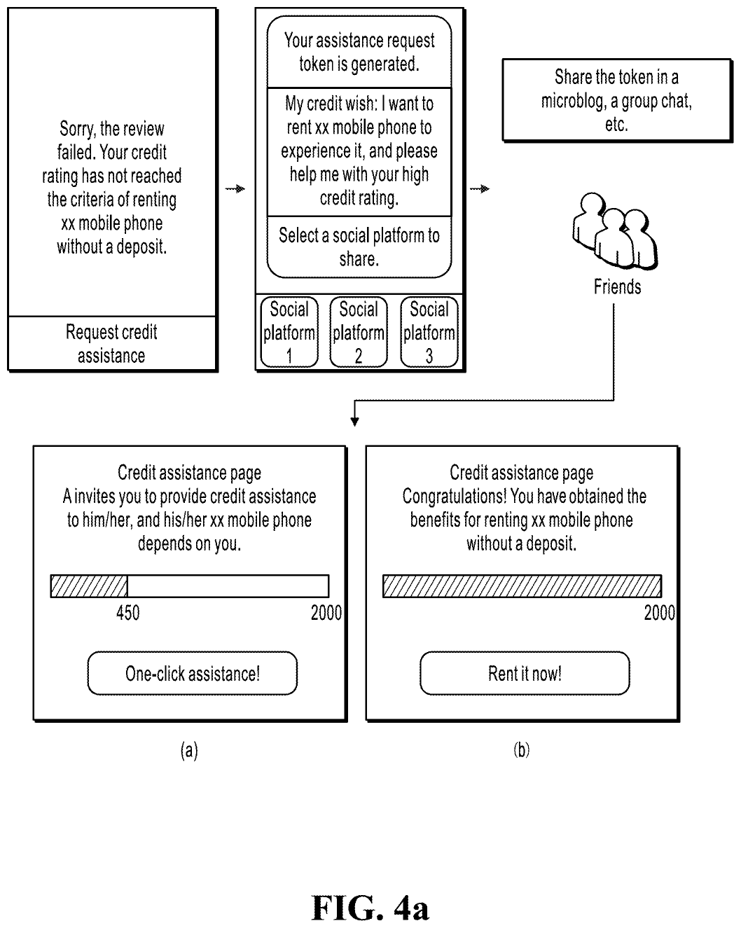

The previous describes the credit guarantee-based service processing method provided in the implementations of the present specification. More intuitively, implementations of the present specification further provide schematic diagrams illustrating some page effects involved in a specific implementation solution of the previous service processing method in an actual application scenario, as shown in FIG. 4a and FIG. 4b.

In FIG. 4a, assume that the first user is user A and the second user is one or more friends of A. User A applies for deposit-free renting of xx mobile phone on a certain renting platform. If a credit rating of user A is not qualified and the application is rejected, user A can click the “Request Credit Assistance” button to enable the credit assistance function to invite friends to provide assistance. Certainly, user A can determine, in other ways, whether user A has the above-mentioned deposit-free renting benefits. A client application generates an assistance request token for user A, and the token includes the following text: “My credit wish: I want to rent xx mobile phone to experience it, and please help me with your high credit rating”. Certainly, the token can further include some special identifiers for subsequent authentication. User A can further select a certain social platform to share the token, and three social platforms are shown in the figure for example. Assume that user A shares the token with some friends on platforms such as a microblog and a group chat. According to the token, a friend can execute an operation of agreeing to the assistance request. The figure shows two example credit assistance pages, including assistance progress information in the form of a progress bar (indicating the amount of a current exemptible deposit for example). Page (a) is shown for the friend, and the friend can see the current assistance progress and can click “One-click assistance!” to assist user A. Page (b) is shown for user A. The current progress is full. Based on the assistance of friends, the progress of user A has reached 2000, and user A obtains the deposit-free renting benefits for xx mobile phone and can click “Rent now!” to perform the specific renting service.

In FIG. 4b, a credit assistance page shown for a friend is also displayed. In the credit assistance page, the friend can further exchange a message with user A. Currently, message interaction between other two assisting friends and user A is shown.

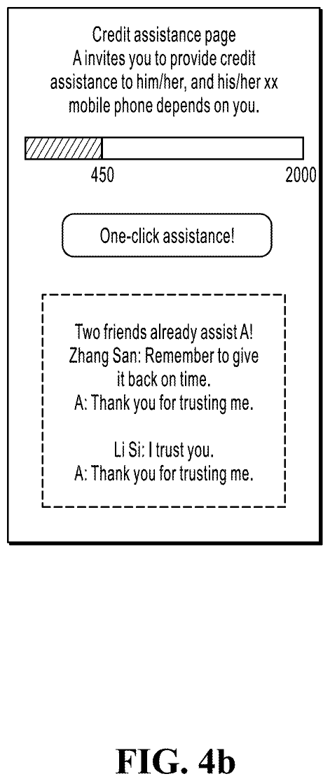

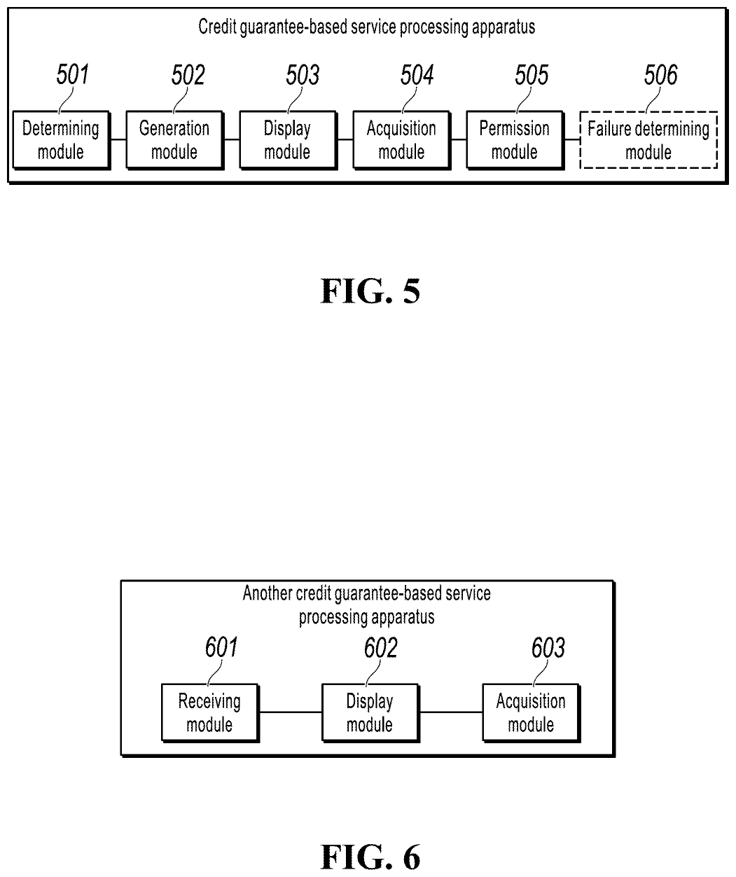

Based on the same idea, implementations of the present specification further provide apparatuses that correspond to the previous methods, as shown in FIG. 5 and FIG. 6.

FIG. 5 is a schematic structural diagram illustrating a credit guarantee-based service processing apparatus corresponding to FIG. 1, according to an implementation of the present specification. A dashed box represents an optional module, and the apparatus includes: a determining module 501, configured to determine, based on a credit rating of a first user, that the first user has not reached a permission condition of a specified service, where the permission condition includes that a credit rating is not less than a specified threshold; a generation module 502, configured to generate an assistance request, used to request one or more second users to use credit ratings of the one or more second users to endorse the first user; a display module 503, configured to display assistance progress information of the first user to represent a credit rating growth status of the first user based on assistance of other users; an acquisition module 504, configured to: if the second user agrees to the assistance request, obtain a credit rating of the first user after being assisted that is calculated based on respective credit ratings of the first user and the second user; and a permission module 505, configured to permit the first user to use the specified service if the credit rating obtained after the assistance enables the first user to meet the permission condition.

Optionally, the specified service includes a deposit-free renting service.

Optionally, that the generation module 502 generates the assistance request specifically includes: the generation module 502 generates an assistance request in a token form, used to share the assistance request with one or more second users by using a current platform or a third-party platform, so the second user obtains a corresponding operation portal through token verification based on the assistance request.

Optionally, the apparatus further includes: a failure determining module 506, configured to determine whether the quantity of the second users that agree to the assistance request reaches a specified threshold; and if the specified threshold is reached, but the credit rating obtained after the assistance still fails to enable the first user to meet the permission condition, determine that the assistance fails, and restore the credit rating of the first user to the credit before the assistance.

Optionally, the second user is a friend of the first user on a current platform and/or a third-party platform; and calculating, based on credit ratings of the first user and the second user, a credit rating of the first user after being assisted specifically includes: verifying the friendship based on information about the first user and information about the second user, so as to determine an actual relationship between the first user and the second user; setting a corresponding relationship weight based on the actual relationship; and calculating, based on the relationship weight, the specified threshold, and the credit ratings of the first user and the second user, the credit rating of the first user after being assisted.

Optionally, the credit rating of the first user after being assisted is calculated based on the following equation:

Sᵤ+=(Sᵥ−Sₜ)*W_{u,v}*ζ;

Sᵤ represents a current credit rating of the first user, Sᵥ represents a credit rating of the second user, Sₜ represents the specified threshold of the credit rating in the permission condition, W_{u,v} represents a relationship weight between the first user and the second user, and ζ represents a damping coefficient.

Optionally, that the display module 503 displays the assistance progress information of the first user further includes: the display module 503 displays automatically generated message information and/or message information proactively submitted by each of the second users who have agreed to the assistance request, where the displayed message information is used to express at least one of the following intentions: explicitly indicating assistance behavior of each of the second users against the first user, and reminding the first user to implement contract fulfillment for the assistance behavior.

FIG. 6 is a schematic structural diagram illustrating a credit guarantee-based service processing apparatus corresponding to FIG. 3, according to implementations of the present specification. The apparatus includes: a receiving module 601, configured to receive an assistance request sent by a first user to a second user, where the assistance request is used to request the second user to use a credit rating of the second user to endorse the first user; a display module 602, configured to display assistance progress information of the first user to represent a credit rating growth status of the first user based on assistance of other users; an acquisition module 603, configured to: in response to an operation indicating that the second user agrees to the assistance request, obtain a credit rating of the first user after being assisted that is calculated based on respective credit ratings of the first user and the second user, so as to update the assistance progress information.

Optionally, that the display module 602 displays the assistance progress information of the first user further includes: the display module 602 displays automatically generated message information and/or message information proactively submitted by each of the second users who have agreed to the assistance request, where the displayed message information is used to express at least one of the following intentions: explicitly indicating assistance behavior of each of the second users against the first user, and reminding the first user to implement contract fulfillment for the assistance behavior.

Based on the same idea, an implementation of the present specification further provides a device and a non-volatile computer storage medium that corresponds to the previous method.

Implementations of the present specification provide a credit guarantee-based service processing device corresponding to FIG. 1, and the device includes: at least one processor; and a memory communicatively connected to the at least one processor; where the memory stores instructions that can be executed by the at least one processor, and the instructions are executed by the at least one processor, to enable the at least one processor to: determine, based on a credit rating of a first user, that the first user has not reached a permission condition of a specified service, where the permission condition includes that a credit rating is not less than a specified threshold; generate an assistance request, used to request one or more second users to use credit ratings of the one or more second users to endorse the first user; display assistance progress information of the first user to represent a credit rating growth status of the first user based on assistance of other users; if the second user agrees to the assistance request, obtain a credit rating of the first user after being assisted that is calculated based on respective credit ratings of the first user and the second user; and permit the first user to use the specified service if the credit rating obtained after the assistance enables the first user to meet the permission condition.

Implementations of the present specification provide a credit guarantee-based service processing device corresponding to FIG. 3, and the device includes: at least one processor; and a memory communicatively connected to the at least one processor; where the memory stores instructions that can be executed by the at least one processor, and the instructions are executed by the at least one processor, to enable the at least one processor to: receive an assistance request sent by a first user to a second user, where the assistance request is used to request the second user to use a credit rating of the second user to endorse the first user; display assistance progress information of the first user to represent a credit rating growth status of the first user based on assistance of other users; in response to an operation indicating that the second user agrees to the assistance request, obtain a credit rating of the first user after being assisted that is calculated based on respective credit ratings of the first user and the second user, so as to update the assistance progress information.

Implementations of the present specification provide a non-volatile computer storage medium that corresponds to FIG. 1, where the non-volatile computer storage medium stores computer executable instructions, and the computer executable instructions are set to: determine, based on a credit rating of a first user, that the first user has not reached a permission condition of a specified service, where the permission condition includes that a credit rating is not less than a specified threshold; generate an assistance request, used to request one or more second users to use credit ratings of the one or more second users to endorse the first user; display assistance progress information of the first user to represent a credit rating growth status of the first user based on assistance of other users; if the second user agrees to the assistance request, obtain a credit rating of the first user after being assisted that is calculated based on respective credit ratings of the first user and the second user; and permit the first user to use the specified service if the credit rating obtained after the assistance enables the first user to meet the permission condition.

Implementations of the present specification provide a non-volatile computer storage medium that corresponds to FIG. 3, where the non-volatile computer storage medium stores computer executable instructions, and the computer executable instructions are set to: receive an assistance request sent by a first user to a second user, where the assistance request is used to request the second user to use a credit rating of the second user to endorse the first user; display assistance progress information of the first user to represent a credit rating growth status of the first user based on assistance of other users; in response to an operation indicating that the second user agrees to the assistance request, obtain a credit rating of the first user after being assisted that is calculated based on respective credit ratings of the first user and the second user, so as to update the assistance progress information.

Specific implementations of the present specification are described above. Other implementations fall within the scope of the appended claims. In some situations, the actions or steps described in the claims can be performed in an order different from the order in the implementations and the desired results can still be achieved. In addition, the process scaled in the accompanying drawings does not necessarily need a particular execution order to achieve the desired results. In some implementations, multi-tasking and concurrent processing is feasible or may be advantageous.

The implementations in the present specification are described in a progressive way. For same or similar parts of the implementations, references can be made to the implementations. Each implementation focuses on a difference from other implementations. Especially, an apparatus implementation, a device implementation, a non-volatile computer storage medium implementation are similar to a method implementation, and therefore are described briefly. For related parts, references can be made to the descriptions in the method implementation.

The apparatus, the device, and the non-volatile computer storage medium provided in the implementations of the present specification correspond to the method. Therefore, the apparatus, the device, and the non-volatile computer storage medium also have beneficial technical effects similar to those of the corresponding method. The beneficial technical effects of the method are described in detail above, so the beneficial technical effects of the corresponding apparatus, device, and non-volatile computer storage medium are omitted here.

In the 1990s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures can be considered as direct improvements to hardware circuit structures. A designer usually programs an improved method procedure into a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the PLD is determined by a user through device programming. The designer performs programming to “integrate” a digital system to a PLD without requesting a chip manufacturer to design and produce an application-specific integrated circuit chip. In addition, the programming is mostly implemented by modifying “logic compiler” software instead of manually making an integrated circuit chip. This is similar to a software compiler used for program development and compiling. However, original code before compiling is also written in a specific programming language, which is referred to as a hardware description language (HDL). There are many HDLs, such as an Advanced Boolean Expression Language (ABEL), an Altera Hardware Description Language (AHDL), Confluence, a Cornell University Programming Language (CUPL), HDCal, a Java Hardware Description Language (JHDL), Lava, Lola, MyHDL, PALASM, and a Ruby Hardware Description Language (RHDL). Currently, a Very-High-Speed Integrated Circuit Hardware Description Language (VHDL) and Verilog are most commonly used. A person skilled in the art should also understand that a hardware circuit that implements a logical method procedure can be readily obtained once the method procedure is logically programmed by using the several described hardware description languages and is programmed into an integrated circuit.

A controller can be implemented by using any appropriate method. For example, the controller can be a microprocessor or a processor, or a computer-readable medium that stores computer readable program code (such as software or firmware) that can be executed by the microprocessor or the processor, a logic gate, a switch, an application-specific integrated circuit (ASIC), a programmable logic controller, or a built-in microprocessor. Examples of the controller include but are not limited to the following microprocessors: ARC 625D, Atmel AT91SAM, Microchip PIC18F26K20, and Silicone Labs C8051F320. The memory controller can also be implemented as a part of the control logic of the memory. A person skilled in the art also knows that, in addition to implementing the controller by using the computer readable program code, logic programming can be performed on method steps to permit the controller to implement the same function in forms of the logic gate, the switch, the application-specific integrated circuit, the programmable logic controller, and the built-in microcontroller. Therefore, the controller can be considered as a hardware component, and an apparatus configured to implement various functions in the controller can also be considered as a structure in the hardware component. Or the apparatus configured to implement various functions can even be considered as both a software module implementing the method and a structure in the hardware component.

The system, device, module, or unit illustrated in the previous implementations can be implemented by using a computer chip or an entity, or can be implemented by using a product having a certain function. A typical implementation device is a computer. The computer can be, for example, a personal computer, a laptop computer, a cellular phone, a camera phone, a smartphone, a personal digital assistant, a media player, a navigation device, an email device, a game console, a tablet computer, or a wearable device, or a combination of any of these devices.

For ease of description, the apparatus above is described by dividing functions into various units. Certainly, when the present specification is implemented, a function of each unit can be implemented in one or more pieces of software and/or hardware.

A person skilled in the art should understand that an implementation of the present specification can be provided as a method, a system, or a computer program product. Therefore, the implementations of the present specification can use a form of hardware only implementations, software only implementations, or implementations with a combination of software and hardware. Moreover, the implementations of the present specification can use a form of a computer program product that is implemented on one or more computer-usable storage media (including but not limited to a disk memory, a CD-ROM, an optical memory, etc.) that include computer-usable program code.

The present specification is described with reference to the flowcharts and/or block diagrams of the method, the device (system), and the computer program product based on the implementations of the present specification. It is worthwhile to note that computer program instructions can be used to implement each process and/or each block in the flowcharts and/or the block diagrams and a combination of a process and/or a block in the flowcharts and/or the block diagrams. These computer program instructions can be provided for a general-purpose computer, a dedicated computer, an embedded processor, or a processor of another programmable data processing device to generate a machine, so the instructions executed by the computer or the processor of the another programmable data processing device generate a device for implementing a specific function in one or more processes in the flowcharts and/or in one or more blocks in the block diagrams.

These computer program instructions can be stored in a computer readable memory that can instruct the computer or the another programmable data processing device to work in a specific way, so the instructions stored in the computer readable memory generate an artifact that includes an instruction apparatus. The instruction apparatus implements a specific function in one or more processes in the flowcharts and/or in one or more blocks in the block diagrams.

These computer program instructions can be loaded onto the computer or another programmable data processing device, so a series of operations and operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

In a typical configuration, a computing device includes one or more processors (CPU), one or more input/output interfaces, one or more network interfaces, and one or more memories.

The memory include a non-persistent memory, a random access memory (RAM), a non-volatile memory, and/or another form that are in a computer readable medium, for example, a read-only memory (ROM) or a flash memory (flash RAM). The memory is an example of the computer readable medium.

The computer readable medium includes persistent, non-persistent, movable, and unmovable media that can store information by using any method or technology. The information can be a computer readable instruction, a data structure, a program module, or other data. Examples of a computer storage medium include but are not limited to a phase change memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage or another magnetic storage device. The computer storage medium can be used to store information accessible by the calculating device. Based on the definition in the present specification, the computer readable medium does not include transitory computer readable media (transitory media) such as a modulated data signal and carrier.

It is worthwhile to further note that, the terms “include”, “contain”, or their any other variants are intended to cover a non-exclusive inclusion, so a process, a method, a product or a device that includes a list of elements not only includes those elements but also includes other elements which are not expressly listed, or further includes elements inherent to such process, method, product or device. Without more constraints, an element preceded by “includes a . . . ” does not preclude the existence of additional identical elements in the process, method, product or device that includes the element.

A person skilled in the art should understand that an implementation of the present specification can be provided as a method, a system, or a computer program product. Therefore, the present specification can use a form of hardware only implementations, software only implementations, or implementations with a combination of software and hardware. Moreover, the present specification can use a form of a computer program product that is implemented on one or more computer-usable storage media (including but not limited to a disk memory, a CD-ROM, an optical memory, etc.) that include computer-usable program code.

The present specification can be described in the general context of computer-executable instructions, for example, a program module. Generally, the program module includes a routine, a program, an object, a component, a data structure, etc. executing a specific task or implementing a specific abstract data type. The present specification can alternatively be practiced in distributed computing environments in which tasks are performed by remote processing devices that are connected through a communications network. In a distributed computing environment, the program module can be located in both local and remote computer storage media including storage devices.

The implementations in the present specification are described in a progressive way. For same or similar parts of the implementations, references can be made to the implementations. Each implementation focuses on a difference from other implementations. Particularly, a system implementation is similar to a method implementation, and therefore is described briefly. For related parts, references can be made to related descriptions in the method implementation.

The previous descriptions are merely implementations of the present specification, and are not intended to limit the present application. A person skilled in the art can make various modifications and changes to the present application. Any modification, equivalent replacement, or improvement made without departing from the spirit and principle of the present application shall fall within the scope of the claims in the present application.

What is claimed is:

1. A computer-implemented method for authorizing a service based on aggregated credit ratings of multiple users, the method comprising:
determining, by one or more processing devices, that a credit rating of a first user does not satisfy a permission condition of the service, wherein the permission condition comprises that the credit rating of the first user is greater than or equal to a specified threshold;
generating, by the one or more processing devices, an assistance request shareable with at least a second user, the assistance request comprising a request for the second user to authorize use of a credit rating of the second user to endorse the first user;
displaying assistance progress information representing a relative status with respect to a goal, the relative status being calculated based on assistance by one or more of the multiple users;
receiving, by the one or more processing devices, information indicating the second user's authorization for use of the credit rating of the second user to endorse the first user;
responsive to receiving information indicating the second user's authorization for the use of the credit rating of the second user, determining, by the one or more processing devices, an update to the relative status, the updated relative status being determined based on respective credit ratings of the first user and the second user; and
if the permission condition is satisfied based on the updated relative status, permitting the first user to use the service.

2. The computer-implemented method of claim 1, wherein the service comprises a deposit-free renting service.

3. The computer-implemented method of claim 1, wherein generating the assistance request comprises:
generating the assistance request in a token form, wherein the assistance request in the token form is shareable with the second user in a third-party platform, and
wherein the assistance request in the token form is usable by the second user, in an operation platform, to authorize the use of the credit rating of the second user to endorse the first user.

4. The computer-implemented method of claim 1, comprising:
generating one or more further assistance requests for one or more corresponding additional users;
determining that a total number of users providing authorization for use of respective credit ratings to endorse the first user is greater than or equal to a specified threshold,
wherein the updated relative status is further based on respective credit ratings of any of the one or more further users who provide authorization for use of a respective credit rating to endorse the first user;
determining that the permission condition is not satisfied based on the updated relative status; and
based on determining that the total number of users providing authorization for use of respective credit ratings to endorse the first user is greater than or equal to the specified threshold, and based on determining that the permission condition is not satisfied,
determining that credit assistance fails, and
restoring the updated relative status of the first user to a status of the first user before assistance.

5. The computer-implemented method of claim 1, wherein the second user is a friend of the first user on a current platform or on a third-party platform, and wherein determining the updated relative status of the first user comprises:
based on information about the first user and information about the second user, determining an actual relationship between the first user and the second user;
determining a relationship weight based on the actual relationship; and
determining, based on the relationship weight, the specified threshold, and the respective credit ratings of the first user and the second user, the updated relative status of the first user.

6. The computer-implemented method of claim 1, wherein a difference between the updated relative status of the first user and a status of the first user before assistance is proportional to each of
a difference between the credit rating of the second user and the specified threshold,
a relationship weight between the first user and the second user, and
a damping coefficient.

7. The computer-implemented method of claim 1, wherein displaying the assistance progress information of the first user comprises:
displaying message information corresponding to the second user, wherein the message information expresses at least one of
an explicit indication of assistance to the first user, and
a reminder to the first user to fulfill a contract corresponding to the service.

8. A non-transitory, computer-readable medium storing one or more instructions executable by a computer system to perform operations for authorizing a service based on aggregated credit ratings of multiple users, the operations comprising:
determining, by one or more processing devices, that a credit rating of a first user does not satisfy a permission condition of the service, wherein the permission condition comprises that the credit rating of the first user is greater than or equal to a specified threshold;
generating, by the one or more processing devices, an assistance request shareable with at least a second user, the assistance request comprising a request for the second user to authorize use of a credit rating of the second user to endorse the first user;
displaying assistance progress information representing a relative status with respect to a goal, the relative status being calculated based on assistance by one or more of the multiple users;
receiving, by the one or more processing devices, information indicating the second user's authorization for use of the credit rating of the second user to endorse the first user;
responsive to receiving information indicating the second user's authorization for the use of the credit rating of the second user, determining, by the one or more processing devices, an update to the relative status, the updated relative status being determined based on respective credit ratings of the first user and the second user; and
if the permission condition is satisfied based on the updated relative status, permitting the first user to use the service.

9. The computer-readable medium of claim 8, wherein the service comprises a deposit-free renting service.

10. The computer-readable medium of claim 8, wherein generating the assistance request comprises:
generating the assistance request in a token form, wherein the assistance request in the token form is shareable with the second user in a third-party platform, and
wherein the assistance request in the token form is usable by the second user, in an operation platform, to authorize the use of the credit rating of the second user to endorse the first user.

11. The computer-readable medium of claim 8, wherein the operations comprise:
generating one or more further assistance requests for one or more corresponding additional users;
determining that a total number of users providing authorization for use of respective credit ratings to endorse the first user is greater than or equal to a specified threshold,
wherein the updated relative status is further based on respective credit ratings of any of the one or more further users who provide authorization for use of a respective credit rating to endorse the first user;
determining that the permission condition is not satisfied based on the updated relative status; and
based on determining that the total number of users providing authorization for use of respective credit ratings to endorse the first user is greater than or equal to the specified threshold, and based on determining that the permission condition is not satisfied,
determining that credit assistance fails, and
restoring the updated relative status of the first user to a status of the first user before assistance.

12. The computer-readable medium of claim 8, wherein the second user is a friend of the first user on a current platform or on a third-party platform, and wherein determining the updated relative status of the first user comprises:
based on information about the first user and information about the second user, determining an actual relationship between the first user and the second user;
determining a relationship weight based on the actual relationship; and
determining, based on the relationship weight, the specified threshold, and the respective credit ratings of the first user and the second user, the updated relative status of the first user.

13. The computer-readable medium of claim 8, wherein a difference between the updated relative status of the first user and a status of the first user before assistance is proportional to each of
a difference between the credit rating of the second user and the specified threshold,
a relationship weight between the first user and the second user, and
a damping coefficient.

14. The computer-readable medium of claim 8, wherein displaying the assistance progress information of the first user comprises:
displaying message information corresponding to the second user, wherein the message information expresses at least one of
an explicit indication of assistance to the first user, and
a reminder to the first user to fulfill a contract corresponding to the service.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations for authorizing a service based on aggregated credit ratings of multiple users, the operations comprising:
determining, by one or more processing devices, that a credit rating of a first user does not satisfy a permission condition of the service, wherein the permission condition comprises that the credit rating of the first user is greater than or equal to a specified threshold;
generating, by the one or more processing devices, an assistance request shareable with at least a second user, the assistance request comprising a request for the second user to authorize use of a credit rating of the second user to endorse the first user;
displaying assistance progress information representing a relative status with respect to a goal, the relative status being calculated based on assistance by one or more of the multiple users;
receiving, by the one or more processing devices, information indicating the second user's authorization for use of the credit rating of the second user to endorse the first user;
responsive to receiving information indicating the second user's authorization for the use of the credit rating of the second user, determining, by the one or more processing devices, an update to the relative status, the updated relative status being determined based on respective credit ratings of the first user and the second user; and
if the permission condition is satisfied based on the updated relative status, permitting the first user to use the service.

16. The computer-implemented system of claim 15, wherein the service comprises a deposit-free renting service.

17. The computer-implemented system of claim 15, wherein generating the assistance request comprises:
generating the assistance request in a token form, wherein the assistance request in the token form is shareable with the second user in a third-party platform, and
wherein the assistance request in the token form is usable by the second user, in an operation platform, to authorize the use of the credit rating of the second user to endorse the first user.

18. The computer-implemented system of claim 15, wherein the operations comprise:
generating one or more further assistance requests for one or more corresponding additional users;
determining that a total number of users providing authorization for use of respective credit ratings to endorse the first user is greater than or equal to a specified threshold,
wherein the updated relative status is further based on respective credit ratings of any of the one or more further users who provide authorization for use of a respective credit rating to endorse the first user;
determining that the permission condition is not satisfied based on the updated relative status; and
based on determining that the total number of users providing authorization for use of respective credit ratings to endorse the first user is greater than or equal to the specified threshold, and based on determining that the permission condition is not satisfied,
determining that credit assistance fails, and
restoring the updated relative status of the first user to a status of the first user before assistance.

19. The computer-implemented system of claim 15, wherein the second user is a friend of the first user on a current platform or on a third-party platform, and wherein determining the updated relative status of the first user comprises:
based on information about the first user and information about the second user, determining an actual relationship between the first user and the second user;
determining a relationship weight based on the actual relationship; and
determining, based on the relationship weight, the specified threshold, and the respective credit ratings of the first user and the second user, the updated relative status of the first user.

20. The computer-implemented system of claim 15, wherein a difference between the updated relative status of the first user and a status of the first user before assistance is proportional to each of
a difference between the credit rating of the second user and the specified threshold,
a relationship weight between the first user and the second user, and
a damping coefficient.

21. The computer-implemented system of claim 15, wherein displaying the assistance progress information of the first user comprises:
displaying message information corresponding to the second user, wherein the message information expresses at least one of
an explicit indication of assistance to the first user, and
a reminder to the first user to fulfill a contract corresponding to the service.
